(19) United States
(12) Patent Application Publication
(10) Pub. No.: US 2020/0094615 A1
(43) Pub. Date: Mar. 26, 2020

(54) STRING ART ORNAMENT AND PATTERNED MOLD THEREOF

(71) Applicant: TENG-KUEI CHEN, TAIPEI (TW)

(72) Inventor: TENG-KUEI CHEN, TAIPEI (TW)

(21) Appl. No.: 16/140,856

(22) Filed: Sep. 25, 2018

(51) Int. Cl. B44C 3/00

(52) U.S. Cl. CPC B44C 3/00

(57) ABSTRACT

A string art ornament has a patterned mold and at least one string. The patterned mold has a contour line portion and multiple string holes arranged along the contour line portion. The at least one string is mounted through the string holes of the patterned mold. Each of the at least one string extends from one of the string holes to the other string hole continuously. A user does not have to form the outline of the pattern with pins. Therefore, making the string art ornament of the present invention is safe and convenient. Furthermore, in addition to being hung on a wall for decoration, the string art ornament can be worn around a neck of the user like a necklace or connected to a pack or a mobile phone like a charm.

### BACKGROUND OF THE INVENTION

### 1. Field of the Invention

The present invention relates to a string art ornament and a patterned mold of the string art ornament, and more particularly to a string art ornament that has a patterned mold with multiple string holes for winding at least one string on the patterned mold.

### 2. Description of the Prior Art(s)

As shown in FIG. 6, a convention string art ornament is created with a board 31, multiple pins 32, and at least one string 33. The pins 32 are hammered on the board 31 and form an outline of a specific pattern. The at least one string 33 is strung between the pins 32 to form geometric patterns.

However, since each of the pins 32 has a sharp tip, kids might be stabbed by the pins 32 accidentally. In addition, fingers of the kids might be knocked by a hammer for hammering the pins 32. Therefore, making the conventional string art ornament alone is dangerous for the kids.

Moreover, the conventional string art ornament with the pins 32 protruding from the board 31 and the at least one string 33 strung between the pins 32 is three-dimensional and bulky. Hence, although the conventional string art ornament can be hung on a wall for decoration, the conventional string art ornament cannot be worn around a neck of the kid like a necklace or connected to a pack or a mobile phone like a charm.

To overcome the shortcomings, the present invention provides a string art ornament and a patterned mold of the string art ornament to mitigate or obviate the aforementioned problems.

### SUMMARY OF THE INVENTION

The main objective of the present invention is to provide a string art ornament that has a patterned mold and at least one string. The patterned mold has a contour line portion and multiple string holes. The string holes are formed through and are arranged along the contour line portion. The at least one string is mounted through the string holes of the patterned mold. Each of the at least one string extends from one of the string holes to the other string hole continuously.

A user does not have to form the outline of the pattern with pins. Therefore, making the string art ornament of the present invention is safe and convenient. Furthermore, since the at least one string is disposed and strung on the pattern mold, the string art ornament is approximately two-dimensional. Accordingly, in addition to being hung on a wall for decoration, the string art ornament can be worn around a neck of the user like a necklace or connected to a pack or a mobile phone like a charm.

Other objectives, advantages and novel features of the invention will become more apparent from the following detailed description when taken in conjunction with the accompanying drawings.

### BRIEF DESCRIPTION OF THE DRAWINGS

FIG. 1 is a front view of a string art ornament in accordance with the present invention;

FIG. 2 is a front view of a patterned mold of the string art ornament in FIG. 1;

FIG. 3 is an enlarged front view of an AA portion of the patterned mold encircled in FIG. 2;

FIG. 4 is an enlarged front view of another embodiment of a patterned mold of a string art ornament in accordance with the present invention;

FIG. 5 is an enlarged front view of still another embodiment of a patterned mold of a string art ornament in accordance with the present invention; and

FIG. 6 is a top view of a conventional string ornament in accordance with the prior art.

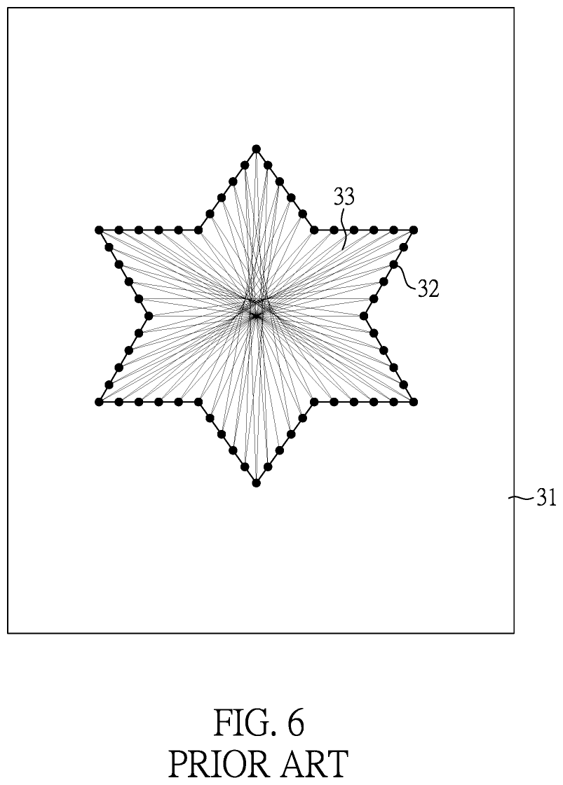

### DETAILED DESCRIPTION OF THE PREFERRED EMBODIMENTS

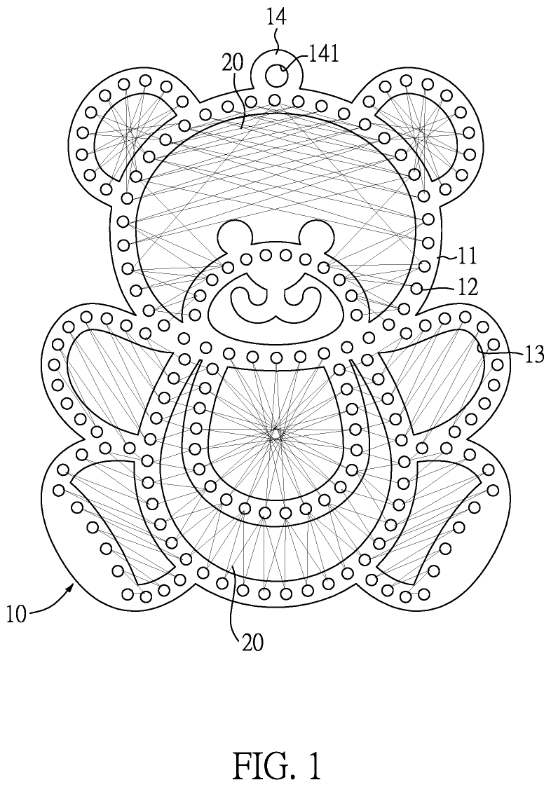

With reference to FIG. 1, a string art ornament in accordance with the present invention comprises a patterned mold 10 and at least one string 20.

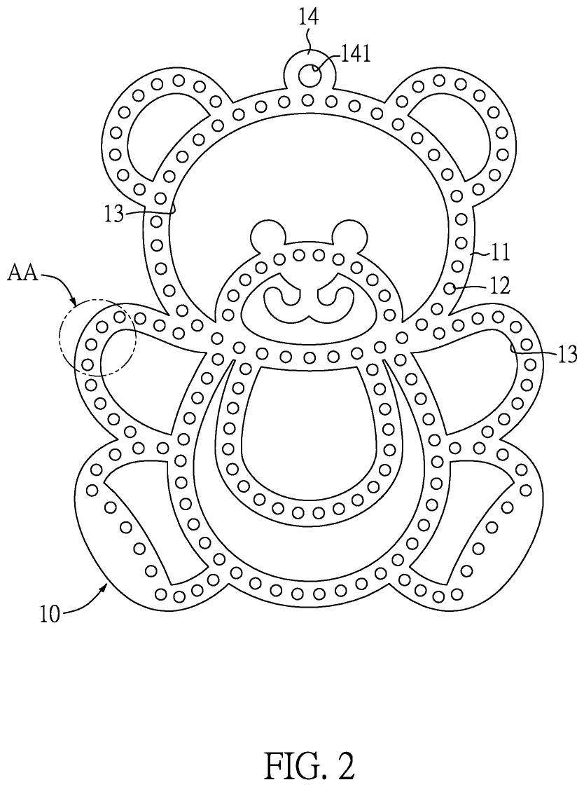

With further reference to FIG. 2, the patterned mold 10 may be a thin flat piece that is made of paper, wood, plastic, metal, and so on. The patterned mold 10 has a contour line portion 11, multiple string holes 12, at least one hollow area 13, and a hanging portion 14.

The contour line portion 11 forms an outline of a pattern. The pattern may be a simple pattern such as a heart, a star, a circle or the like, or a more complicated pattern such as a bear, a mermaid, a dinosaur, a unicorn or the like. In the preferred embodiment as shown in FIGS. 1 and 2 of the present invention, the contour line portion 11 forms the outline of a bear.

The string holes 12 are formed through and arranged along the contour line portion 11. The at least one hollow area 13 is formed through the patterned mold 10. Each of the at least one hollow area 13 is surrounded by the contour line portion 11.

The hanging portion 14 is formed on an outer peripheral edge of the contour line portion 11 and has a hanging hole 141 formed through the hanging portion 14. A hanging rope can be mounted through the hanging hole 141 of the hanging portion 14, so as to hang the string art ornament of the present invention on an appropriate place.

As shown in FIG. 1, the at least one string 20 is mounted through the string holes 12 of the patterned mold 10. Each of the at least one string 20 extends from one of the string holes 12 to the other string hole 12 continuously and passes across one of the at least one hollow area 13 to form geometric patterns in the hollow area 13.

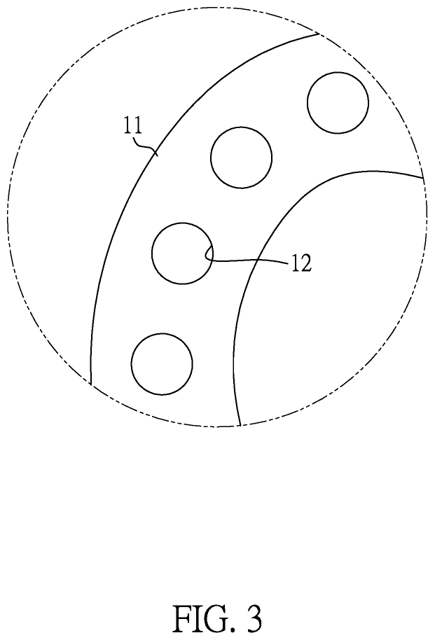

With further reference to FIG. 3, each of the string holes 12 on the contour line portion 11 may be a circular hole.

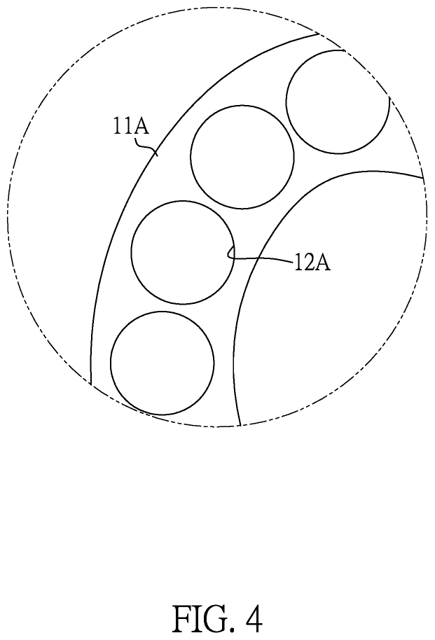

With further reference to FIG. 4, each of the string holes 12A on the contour line portion 11A may be an enlarged circular hole. The enlarged circular hole allows the at least one string 20 to pass therethrough more than once at the same time.

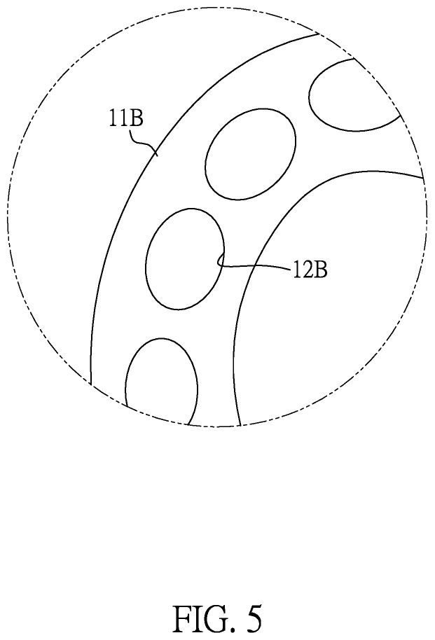

With further reference to FIG. 5, each of the string holes 12B on the contour line portions 11B may be elongated. In the preferred embodiment, the elongated string hole 12B is formed as an oval hole. The elongated string hole 12B also allows the at least one string 20 to pass therethrough more than once at the same time.

The string art ornament as described has the following advantages. A user does not have to form the outline of the pattern with pins. Therefore, making the string art ornament of the present invention is safe and convenient. Furthermore, since the at least one string 20 is disposed and strung on the pattern mold 10, the string art ornament is approximately two-dimensional. Accordingly, in addition to being hung on a wall for decoration, the string art ornament can be worn around a neck of the user like a necklace or connected to a pack or a mobile phone like a charm.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A string art ornament comprising:
a patterned mold having
a contour line portion; and
multiple string holes formed through and arranged along the contour line portion; and
at least one string mounted through the string holes of the patterned mold, and each of the at least one string extending from one of the string holes to the other string hole continuously.

2. The string art ornament as claimed in claim 1, wherein the patterned mold further has at least one hollow area formed through the patterned mold, and each of the at least one hollow area is surrounded by the contour line portion.

3. The string art ornament as claimed in claim 2, wherein each of the at least one string passes across one of the at least one hollow area.

4. The string art ornament as claimed in claim 1, wherein each of the string holes is a circular hole.

5. The string art ornament as claimed in claim 2, wherein each of the string holes is a circular hole.

6. The string art ornament as claimed in claim 1, wherein each of the string holes is elongated.

7. The string art ornament as claimed in claim 2, wherein each of the string holes is elongated.

8. The string art ornament as claimed in claim 1, wherein the patterned mold further has a hanging portion formed on an outer peripheral edge of the contour line portion and having a hanging hole formed through the hanging portion.

9. The string art ornament as claimed in claim 2, wherein the patterned mold further has a hanging portion formed on an outer peripheral edge of the contour line portion and having a hanging hole formed through the hanging portion.

10. A patterned mold of a string art ornament having:
a contour line portion; and
multiple string holes formed through and arranged along the contour line portion.

11. The string art ornament as claimed in claim 10, wherein the patterned mold further has at least one hollow area formed through the patterned mold, and each of the at least one hollow area is surrounded by the contour line portion.

12. The string art ornament as claimed in claim 10, wherein each of the string holes is a circular hole.

13. The string art ornament as claimed in claim 11, wherein each of the string holes is a circular hole.

14. The string art ornament as claimed in claim 10, wherein each of the string holes is elongated.

15. The string art ornament as claimed in claim 11, wherein each of the string holes is elongated.

16. The string art ornament as claimed in claim 10, wherein the patterned mold further has a hanging portion formed on an outer peripheral edge of the contour line portion and having a hanging hole formed through the hanging portion.

17. The string art ornament as claimed in claim 11, wherein the patterned mold further has a hanging portion formed on an outer peripheral edge of the contour line portion and having a hanging hole formed through the hanging portion.
